(19) United States
(12) Patent Application Publication
(10) Pub. No.: US 2018/0329394 A1
(43) Pub. Date: Nov. 15, 2018

(54) RAPID CONTROL PROTOTYPING SYSTEM

(71) Applicant: FUJITSU LIMITED, Kawasaki-shi (JP)

(72) Inventors: Atsushi Manabe, Kamakura (JP); Yu Yonezawa, Sagamihara (JP)

(73) Assignee: FUJITSU LIMITED, Kawasaki-shi (JP)

(21) Appl. No.: 15/969,822

(22) Filed: May 3, 2018

(30) Foreign Application Priority Data
May 15, 2017 (JP) 2017-096283

(51) Int. Cl. G05B 19/4099; B33Y 50/02

(52) U.S. Cl. CPC G05B 19/4099; H02M 3/33576; B33Y 50/02

(57) ABSTRACT

A rapid control prototyping system includes a power supply circuit, a control circuit coupled to the power supply circuit by a plurality of wirings and controls the power supply circuit, the control circuit including a delay amount measuring circuit that output pulses to the power supply circuit by the plurality of wirings and counts reflected pulses by an input of the power supply circuit, a processor that calculates a delay amount of each of the plurality of wirings according to count value of reflected pulses, calculates an offset amount which is a difference between a maximum value of the calculated delay amounts, and delays control signals of the power supply circuit by the offset amount in accordance with each of the plurality of wirings when the control circuit controlling the power supply circuit.

### CROSS-REFERENCE TO RELATED APPLICATION

This application is based upon and claims the benefit of priority of the prior Japanese Patent Application No. 2017-96283, filed on May 15, 2017, the entire contents of which are incorporated herein by reference.

### FIELD

The embodiment discussed herein is related to a rapid control prototyping system.

### BACKGROUND

As a development method of a control program of an electronic control unit (ECU) which is mounted in a vehicle or the like, a method of automatically generating a source code of the control program using a computer for developing in which a simulator program is installed is known. This method is known as a model based development (MBD), and is used for performing creation of a control model in which a control logic is graphically represented by a block line diagram or the like and verification of the control model with respect to a control specification, that is, a compatibility of the control logic. Also, the source code of the control program is automatically generated from the verified control model. When the MBD is used, the control program of the ECU is effectively developed, a time for development is shortened, and thus development costs are reduced.

In the MBD, before automatically generating the code, whether or not the control logic is correctly designed is checked. Therefore, a rapid control prototyping (RCP), in which the control logic is converted to not a MPU for mass-producing but a high-performance computer (calculator), an operation of a mass-producing engine of a prototype or the like is checked, and correctness of the control model is verified, is performed.

The RCP is a system which faithfully realizes the control model which is verified by a computer simulation by a high-performance calculator seamlessly, and verifies a target to be controlled of a prototype. When the RCP is used, the control model can be verified without generating a program.

It is proposed that the RCP is applied to fields other than fields relating to vehicles and efficiency of development is improved. For example, an RCP system including a calculator, an MPU, and a bridge which connects the calculator to the MPU and DMA-transmits data between the calculator and the MPU is known. When such an RCP system is used, it is possible to reliably perform a control of the power supply device per cycle and verify the control logic for controlling the power supply device.

When an operation of the power supply device is verified by the RCP system, the RCP system and the power supply device are connected to each other with a plurality of wirings. Since the plurality of wirings connecting the RCP system and the power supply device has delay amounts in accordance with lengths or the like of the wirings, when the lengths of the plurality of wirings are different from each other, there is a concern that an operation being performed by the control program which is created from the control model verified by the RCP system may be different from a desired operation.

The following is a reference document.
[Document 1] Japanese Laid-open Patent Publication No. 2016-63727.

### SUMMARY

According to an aspect of the invention, a rapid control prototyping system includes a power supply circuit, a control circuit coupled to the power supply circuit by a plurality of wirings and controls the power supply circuit, the control circuit including a delay amount measuring circuit that output pulses to the power supply circuit by the plurality of wirings and counts reflected pulses by an input of the power supply circuit, a processor that calculates a delay amount of each of the plurality of wirings according to count value of reflected pulses, calculates an offset amount which is a difference between a maximum value of the calculated delay amounts, and delays control signals of the power supply circuit by the offset amount in accordance with each of the plurality of wirings when the control circuit controlling the power supply circuit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1A is a circuit diagram of a digital power supply device;

FIG. 1B is a block diagram of a digital power supply RCP system for generating a control program of the digital power supply device illustrated in FIG. 1A;

FIG. 2A is a diagram illustrating a connection relationship between a PWM signal processing unit included in the digital power supply RCP system and switches included in the power supply device;

FIG. 2B is a diagram illustrating an example of an operation of the switch;

FIG. 3A is a block diagram of the RCP system according to an embodiment;

FIG. 3B is a functional block diagram of a CPU illustrated in FIG. 3A;

FIG. 4 is a diagram illustrating a connection relationship between a delay amount measuring circuit and wirings and a power supply circuit;

FIG. 5 is a timing chart illustrating an operation of the delay amount measuring circuit;

FIG. 6 is a flow chart of an offset amount calculating process by a CPU;

FIG. 7A is a diagram illustrating an example of a delay amount calculated by a delay amount calculating unit;

FIG. 7B is a diagram illustrating an offset amount calculated by an offset amount calculating unit from the delay amount illustrated in FIG. 7A;

FIG. 8A is a diagram illustrating a simulation model in which an operation simulation of the delay amount measuring circuit is executed;

FIG. 8B is a first diagram illustrating a simulation result executed using the simulation model of FIG. 8A;

FIG. 9A is a second diagram illustrating the simulation result executed using the simulation model of FIG. 8A; and

FIG. 9B is a diagram illustrating relationships between lengths of the wirings and the delay amounts in the simulation result illustrated in FIG. 9A.

### DESCRIPTION OF EMBODIMENT

With reference to drawings hereinafter, an RCP system according to an embodiment will be described. However, a technical range of the embodiment is not limited to this embodiment.

RCP System Relating to RCP System According to Embodiment Before describing the RCP system according to the embodiment, an RCP system relating to the RCP system according to the embodiment will be described.

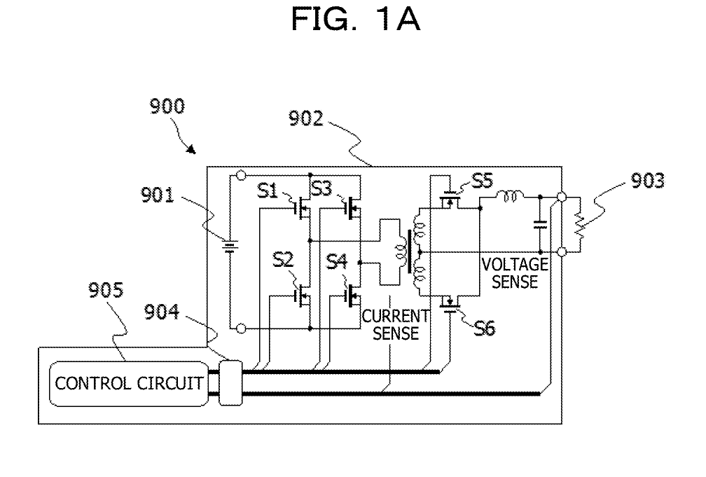

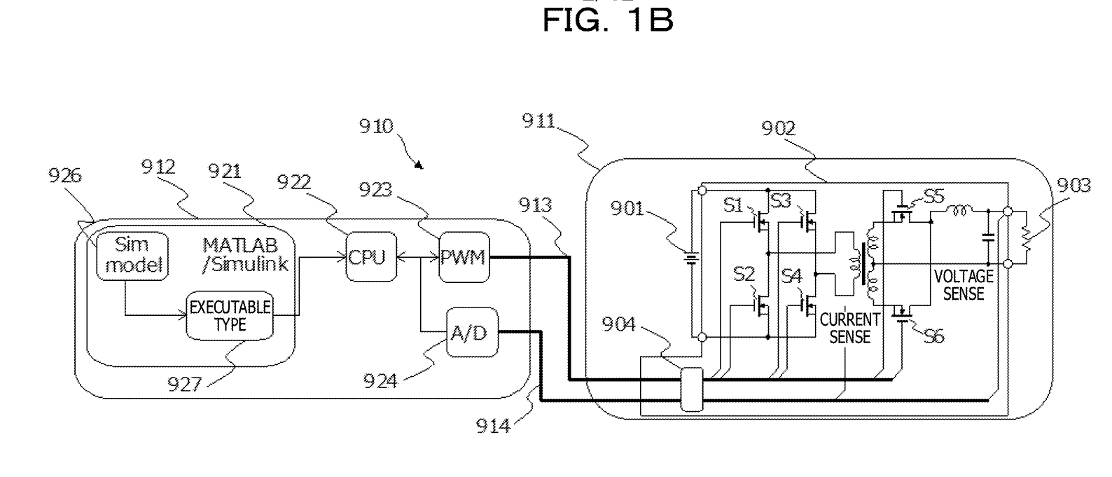

FIG. 1A is a circuit diagram of a digital power supply device, and FIG. 1B is a block diagram of a digital power supply RCP system for generating a control program of the digital power supply device illustrated in FIG. 1A.

A digital power supply device 900 includes a DC power supply 901, a DC-DC converting circuit 902, and a load 903. The DC power supply 901 is, for example, a primary battery, and supplies a predetermined DC voltage to the DC-DC converting circuit 902. The DC-DC converting circuit 902 includes a gate driver 904, a control circuit 905 which is a microprocessor as an example, and switches S1 to S6 which are MOSFETs in accordance with a pulse width modulation (PWM) signal which is a control signal input from the control circuit 905. The DC-DC converting circuit 902 DC-DC-converts a DC voltage which is supplied from the DC power supply 901 by turning on or off the switches S1 to S6 so as to output the converted DC voltage to the load 903. The frequency of the PWM signal is, for example, 100 kHz, and a pulse width of a pulse included in the PWM signal is approximately 5 μs. Since a configuration and a function of the DC-DC converting circuit 902 are widely known, detail description thereof will be omitted herein.

The load 903 is, for example, a resistor, and is connected to an output terminal of the DC-DC converting circuit 902. The gate driver 904 outputs the PWM signal input from the control circuit 905 to each of the switches S1 to S6, and outputs a detect signal indicating an output voltage and a supplying current of the DC-DC converting circuit 902 to the control circuit 905.

The control circuit 905 outputs the PWM signal according to the output voltage of the DC-DC converting circuit 902 to the switches S1 to S6, based on a predetermined control program. The control circuit 905 feedback-controls the output voltage of the DC-DC converting circuit 902 so that the output voltage of the DC-DC converting circuit 902 becomes a predetermined voltage based on the control program. The control program which operates the control circuit 905 is generated by automatically generating a code based on a result verified by the RCP.

The digital power supply RCP system 910 includes a power supply device 911 and an RCP system 912. The power supply device 911 does not include the control circuit 905, and is different from the digital power supply device 900 in that the power supply device is connected to the RCP system 912 through a control wiring 913 through which the control signal is transmitted and a detecting wiring 914 through which the detect signal is transmitted. Since configurations and functions of configuration components of the power supply device 911 are the same as configurations and functions of configuration components of the digital power supply device 900 to which the same numeral is given, detail description thereof will be omitted herein.

The RCP system 912 includes a personal computer (PC) 921, a CPU 922, a PWM signal processing unit 923, and an A/D converter 924. The PC 921 creates a simulation model 926 by MATLAB (registered trademark)/Simulink, converts the simulation model 926 to an executable type data 927, and downloads the converted executable type data 927 to the CPU 922.

The CPU 922, the PWM signal processing unit 923, and the A/D converter 924 constitutes the RCP device which generates an AD value by AD-converting a detect signal, calculates a difference between a target value and an AD value, and generates a PWM signal from compensation value data in accordance with the calculated difference so as to output the PWM signal to the power supply device 911.

The CPU 922 includes components similar to those of a general PC architecture such as a storage unit, and an interface unit in addition to a calculation processing unit. Based on the executable type data 927 which is downloaded from a PC 921, the CPU 922 generates compensation value data in accordance with deference between an AD value input from the A/D converter 924 and a target value, and outputs the generated compensation value data to the PWM signal processing unit 923.

The PWM signal processing unit 923 generates the PWM signal from the compensation value data input from the CPU 922, and outputs the generated PWM signal to the power supply device 911. The A/D converter 924 generates the AD value by AD-converting the detect signal input from the power supply device 911, and outputs an AD value signal indicating the generated AD value to the CPU 922. Signals which are transmitted and received by the CPU 922, the PWM signal processing unit 923, and the A/D converter 924 may be transmitted and received through a bridge.

When the RCP system 912 uses an RCP device which is constituted by the CPU 922, the PWM signal processing unit 923, and the A/D converter 924 instead of the PC 921, the RCP system is possible to be operated at high speed, and thus it is possible to verify a compatibility of a control model which controls the power supply device.

However, in the digital power supply RCP system 910, the PWM signal for controlling the switches S1 to S6 is transmitted from the digital power supply RCP system 910 through the control wiring 913, and thus there is a concern that the PWM signal be influenced by a delay amount of the wiring included in the control wiring 913.

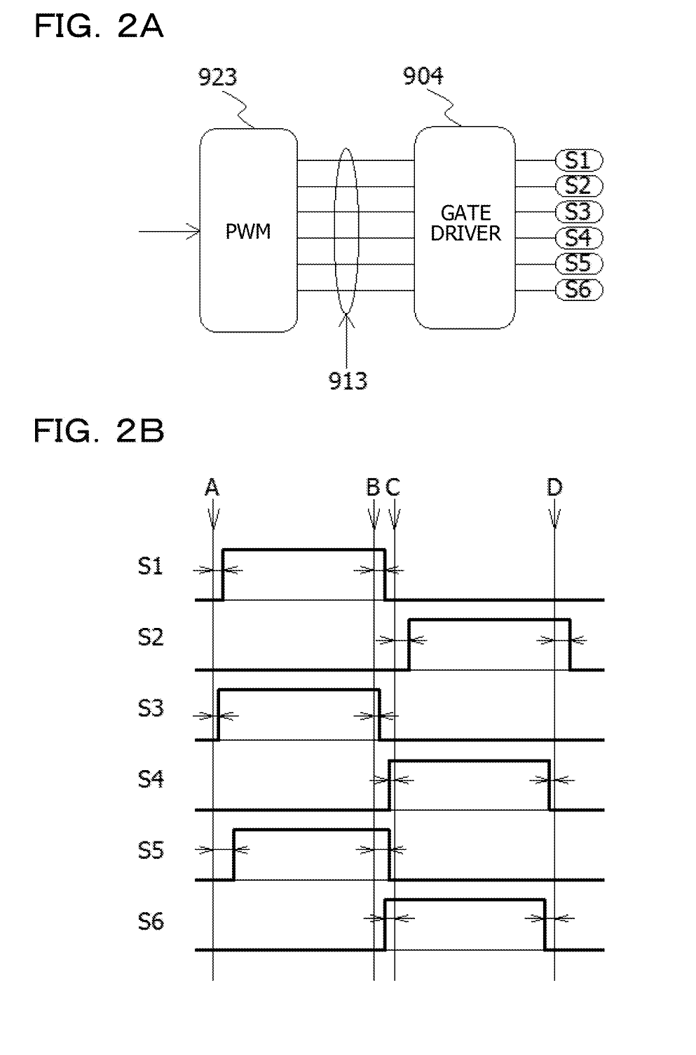

FIG. 2A is a diagram illustrating a connection relationship between the PWM signal processing unit 923 included in the digital power supply RCP system 910 and the switches S1 to S6 included in the power supply device 911, and FIG. 2B is a diagram illustrating an example of operations of the switches S1 to S6. In FIG. 2B, arrows A to D each indicate a timing when the PWM signal is output from the PWM signal processing unit 923.

The PWM signal processing unit 923 and the gate driver 904 driving each of the switches S1 to S6 are connected to each other with six wirings included in the control wiring 913. It is preferable that lengths of the wirings connecting the PWM signal processing unit 923 and the gate driver 904 to each other are the same as each other, but the lengths of the wirings are actually different from each other. Since the lengths of the wirings connecting the PWM signal processing unit 923 and the gate driver 904 to each other are actually different from each other, there is a concern that deviation occurs between a control characteristic of simulation and a control characteristic when the switches S1 to S6 are actually controlled by the control circuit 905. For example, when a frequency of the PWM signal is approximately 100 kHz, since it is desirable that a pulse width be controlled at 1 ns or less degree, there is a concern that a control of the lengths of the wirings connecting the PWM signal processing unit 923 and the gate driver 904 is influenced. In addition, when the switches S1 to S6 are actually controlled by the control circuit 905, for example, if the switch S1 and the switch S2 are turned on at the same time, there is a concern that the through current occurs between a positive current and a negative current of the DC power supply 901 through the switch S1 and the switch S2. Further, when a dead time for suppressing occurring of the through current is set, there is a concern that deviation between a dead time set in the RCP system 912 and a dead time when the switches S1 to S6 are actually controlled by the control circuit 905 occurs.

### Outline of RCP System According to Embodiment

The RCP system according to the embodiment calculates a delay amount of each of the plurality of wirings when a pulse is transmitted to a power supply circuit through each of the plurality of wirings, with respect to each of the plurality of wirings. The RCP system according to the embodiment calculates an offset amount of each of the plurality of wirings, the offset amount being a difference between a maximum value of the calculated delay amounts and a delay amount of each of the plurality of wirings. In the RCP system according to the embodiment, the RCP device delays the PWM signal which is compensated for so that a voltage corresponding to an output signal of the power supply circuit matches a target value by the offset amount corresponding to each of the plurality of wirings through each of the plurality of wirings, and outputs the PWM signal to the power supply circuit. In the RCP system according to the embodiment, it is possible to verify a correctness of the control model without being influenced by the delay amount of each of the plurality of wirings connecting the RCP system and the power supply device to each other, by delaying the PWM signal by the offset amount and outputting the signal to the power supply circuit.

### Configuration and Function of RCP System According to Embodiment

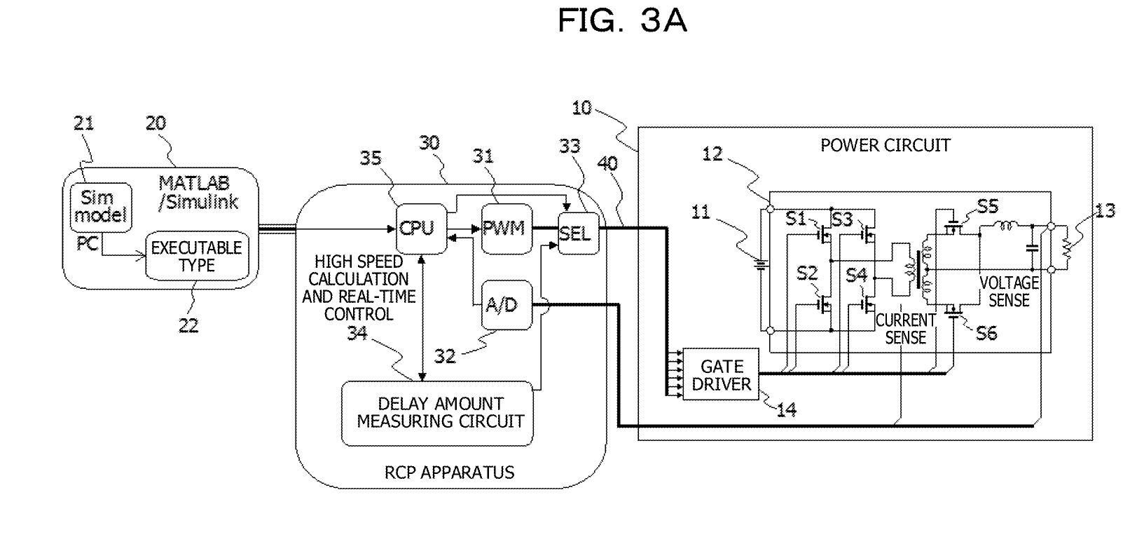

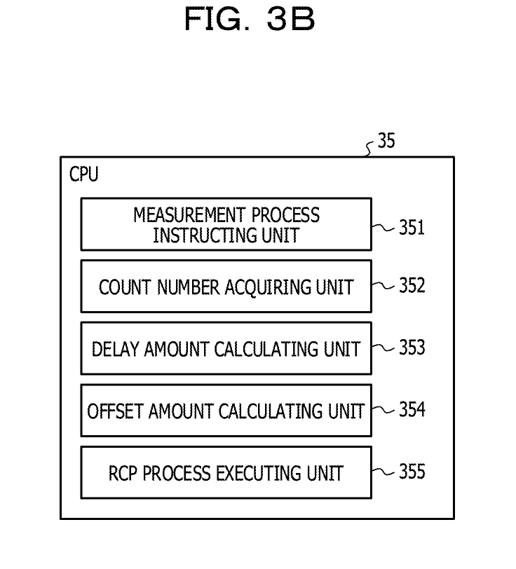

FIG. 3A is a block diagram of the RCP system according to the embodiment, and FIG. 3B is a functional block diagram of the CPU illustrated in FIG. 3A.

The RCP system 1 is constituted by a power supply circuit 10, a PC 20, and an RCP device 30. The power supply circuit 10 includes a DC power supply 11, a DC-DC converting circuit 12, a load 13, and a gate driver 14. Configurations and functions of the DC power supply 11 to the gate driver 14 are the same as configurations and functions of the DC power supply 901 to the gate driver 904, and thus detailed description thereof will be omitted herein.

The PC 20 creates a simulation model 21 by MATLAB (registered trademark)/Simulink, converts the simulation model 926 to executable type data 22, and downloads the converted executable type data 22 to the RCP device 30.

The RCP device 30 includes a PWM signal processing unit 31, an A/D converter 32, a selecting circuit 33, a delay amount measuring circuit 34, and a CPU 35. Configurations and functions of the PWM signal processing unit 31 and the A/D converter 32 are the same as configurations and functions of the PWM signal processing unit 923 and the A/D converter 924, and thus detailed description thereof will be omitted herein.

The selecting circuit 33 selects either of a signal being input from the PWM signal processing unit 31 and a signal being input from the delay amount measuring circuit 34, and outputs the signal to each of the switches S1 to S6 through the gate driver 14, based on an instruction from the CPU 35.

The delay amount measuring circuit 34 outputs a signal for measuring a delay amount of each of the plurality of wirings in each wiring when a pulse is transmitted to the power supply circuit through each of six wirings included in a control wiring 40 based on the instruction from the CPU 35.

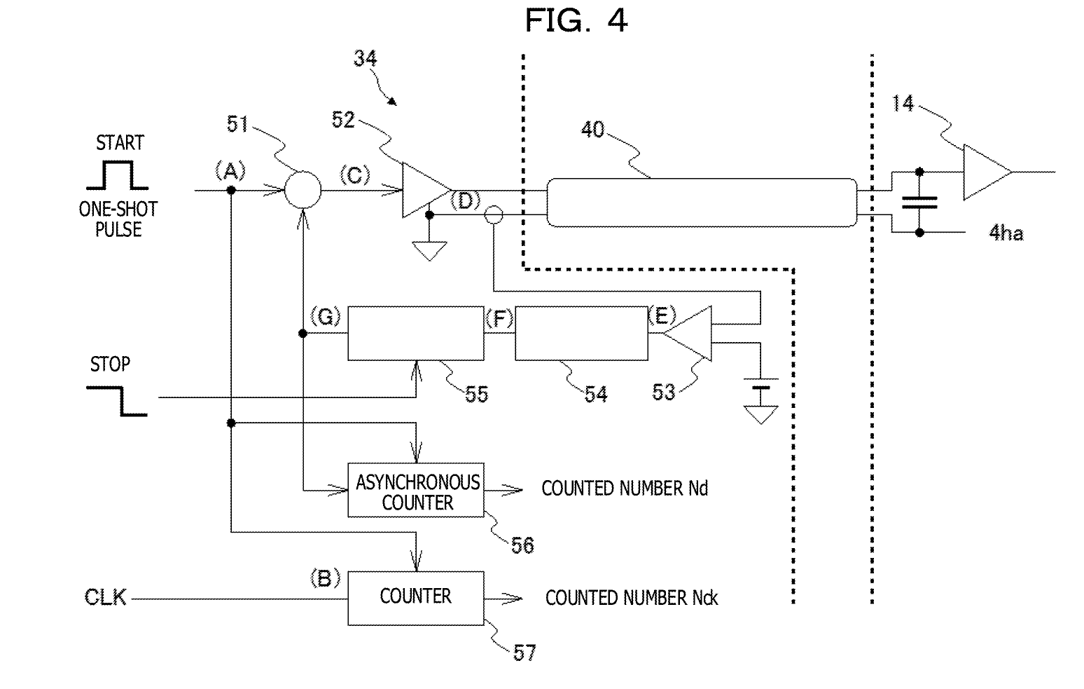

FIG. 4 is a diagram illustrating a connection relationship between the delay amount measuring circuit 34 and the control wiring 40 and the power supply circuit 10. In FIG. 4, the selecting circuit 33 is omitted for the sake of simplicity of description.

The delay amount measuring circuit 34 includes an adder 51, a buffer 52, a comparator 53, a first one-shot pulse circuit 54, a second one-shot pulse circuit 55, an asynchronous counter 56, and a counter 57. The adder 51 to the second one-shot pulse circuit 55 constitute a self-oscillation circuit in which an oscillation cycle is determined in accordance with a length of each of the plurality of wirings included in the control wiring 40. The self-oscillation circuit constituted by the adder 51 to the second one-shot pulse circuit 55 is an example of a pulse generating circuit for generating a pulse.

When a delay amount measuring operation starts, the adder 51 outputs a delay measuring signal input from the CPU 35 to the buffer 52, and outputs an one-shot pulse input from the second one-shot pulse circuit 55 during the delay amount measuring operation to the buffer 52.

The buffer 52 outputs the one-shot pulse input through the adder 51 to the six wirings of S1 to S6 included in the control wiring 40. When the adder 51 outputs the one-shot pulse to each of the wirings included in the control wiring 40, a reflection current flows to a ground wiring when the one-shot pulse is reflected by an input terminal of the gate driver 14 including a parasitic capacitance or the like.

The comparator 53 outputs the pulse to the first one-shot pulse circuit 54 in accordance with an increase of a ground level more than a predetermined threshold voltage by flowing a negative reflection current to the ground wiring.

The first one-shot pulse circuit 54 and the second one-shot pulse circuit 55 are circuits respectively called a monostable multi-vibrator and an one-shot multi-vibrator. The first one-shot pulse circuit 54 generates a first one-shot pulse having a predetermined width in accordance with a rising edge of the pulse output from the comparator 53. The second one-shot pulse circuit 55 generates the second one-shot pulse having a predetermined pulse width in accordance with a rising edge of the first one-shot pulse output from the first one-shot pulse circuit 54, and outputs the second one-shot pulse to the adder 51 and the asynchronous counter 56. In addition, the second one-shot pulse circuit 55 is reset in accordance with an input of an oscillation stop signal.

The first one-shot pulse circuit 54 and the second one-shot pulse circuit 55 may be formed using a dedicated IC for forming the monostable multi-vibrator, or may be formed by combining a comparator and a resistor, and a capacitor and a diode. Since a configuration of the monostable multi-vibrator is widely known, detailed description thereof will be omitted herein.

Each pulse width of the first one-shot pulse being generated by the first one-shot pulse circuit 54 and the second one-shot pulse being generated by the second one-shot pulse circuit 55 is set so as to be half of a cycle of a system clock CLK which is input from CPU 35. That is, when the pulse width of the first one-shot pulse and the pulse width of the second one-shot pulse are added to each other, the pulse widths thereof are adjusted so as to coincide with the cycle of the system clock CLK.

The asynchronous counter 56 and the counter 57 are a counter circuit having a reset function. The asynchronous counter 56 counts the number of rising edges of the second one-shot pulse, and outputs an asynchronous count signal indicating a count number Nd to the CPU 35. The counter 57 counts the number of rising edges of the system clock input from the CPU 35, and outputs a reference count signal indicating a count number Nck to the CPU 35. Since a configuration of the counter circuit is widely known, detailed description thereof will be omitted herein.

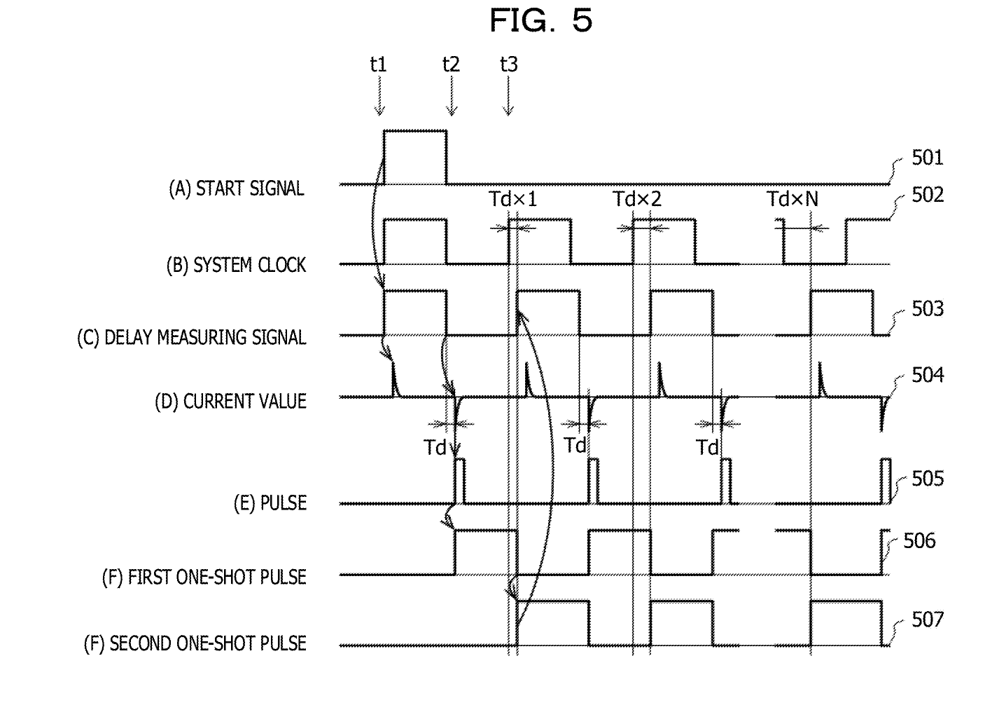

FIG. 5 is a timing chart illustrating operations of the delay amount measuring circuit 34. A waveform 501 indicates a start signal, which is represented by (A) in FIG. 4, input to the adder 51, the asynchronous counter 56, and the counter 57 from the CPU 35. A waveform 502 indicates the system clock CLK, which is represented by (B) in FIG. 4, input to the counter 57 from the CPU 35. A waveform 503 indicates a delay measuring signal, which is represented by (C) in FIG. 4, output to the control wiring 40 from the adder 51. A waveform 504 indicates a current value, which is represented by (D) in FIG. 4, flowing to the ground wiring. A waveform 505 indicates a pulse, which is represented by (E) in FIG. 4, output to the first one-shot pulse circuit 54 from the comparator 53. A waveform 506 indicates the first one-shot pulse, which is represented by (F) in FIG. 4, output to the second one-shot pulse circuit 55 from the first one-shot pulse circuit 54. A waveform 507 indicates the second one-shot pulse, which is represented by (G) in FIG. 4, output to the adder 51 and the asynchronous counter 56 from the second one-shot pulse circuit 55.

First, at a time t1, the CPU 35 outputs the start signal having a predetermined pulse width to the adder 51, the asynchronous counter 56, and the counter 57. The asynchronous counter 56 and the counter 57 are reset in accordance with the input of the start signal.

The adder 51 outputs the input start signal to the control wiring 40 through the buffer 52. A positive current value flows to the ground in accordance with the rising edge of the start signal, and at a timing t2, a negative current value flows to the ground in accordance with the rising edge of the start signal. The positive current value flowing to the ground flows by being delayed by the delay amount Td according to a distance of a reciprocation path of the control wiring 40 from the rising edge of the start signal. In addition, the negative current value flowing to the ground flows by being delayed by the delay amount Td according to a distance of a reciprocation path of the control wiring 40 from the rising edge of the start signal.

The comparator 53 outputs the pulse to the first one-shot pulse circuit 54 in accordance with flowing of the negative current value to the ground. The first one-shot pulse circuit 54 outputs the first one-shot pulse to the second one-shot pulse circuit 55 in accordance with the rising edge of the pulse. At a timing t3, the second one-shot pulse circuit 55 outputs the second one-shot pulse to the adder 51 and the asynchronous counter 56 in accordance with the rising edge of the first one-shot pulse.

The adder 51 outputs the second one-shot pulse input from the second one-shot pulse circuit 55 to the control wiring 40 through the buffer 52. After that, the self-oscillation circuit constituted by the adder 51 to the second one-shot pulse circuit 55 continuously performs the oscillation operation while delaying the first one-shot pulse by the system clock CLK by the delay amount Td in accordance with a distance of a reciprocation path of the control wiring 40 per one cycle. For example, in a N-th cycle, the self-oscillation circuit constituted by the adder 51 to the second one-shot pulse circuit 55 delays the first one-shot pulse by Td×N using the system clock CLK so as to output the first one-shot pulse.

The asynchronous counter 56 counts the number of the second one-shot pulses which are delayed further than the system clock CLK by the delay amount Td per one cycle. Meanwhile, the counter 57 counts the number of the system clocks. When the pulse width of the first one-shot pulse and the pulse width of the second one-shot pulse are added to each other, the pulse widths thereof are adjusted so as to coincide with the cycle of the system clock CLK, and thus a difference of the numbers of pulses being counted by the asynchronous counter 56 and the counter 57 depends on the delay amount Td.

When the oscillation stop signal is input to the second one-shot pulse circuit 55, the self-oscillation circuit constituted by the adder 51 to the second one-shot pulse circuit 55 stops the oscillation operation.

The CPU 35 includes one or a plurality of processors and peripheral circuits thereof. The CPU 35 totally controls all operations of the RCP device 30. The CPU 35 executes processes based on programs stored in a memory (driver program, operating system program, application program, and the like). In addition, the CPU 35 is capable of executing a plurality of programs (application programs, and the like) in parallel.

The CPU 35 includes the same components as those of a general PC architecture such as a storage unit and an interface unit in addition to a calculation processing unit. The CPU 35 generates the compensation value data in accordance with the difference between the AD value input from the A/D converter 32 and the target value based on the executable type data 22 which is downloaded from the PC 20, and executes an RCP process of outputting the generated compensation value data to the PWM signal processing unit 31.

In addition, the CPU 35, in addition to the RCP process, calculates a delay amount of each of the six wirings when the pulse is transmitted to the power supply circuit through the six wirings, and executes an offset amount calculating process of calculating an offset amount which is a difference between a maximum value of the calculated delay amounts and the delay amount of each of the wirings.

In order to executes such a process, the CPU 35 includes a measurement process instructing unit 351, a count number acquiring unit 352, a delay amount calculating unit 353, an offset amount calculating unit 354, and an RCP process executing unit 355. Each unit is a functional module which is realized by a program executed by a processor included in the CPU 35. Otherwise, each unit may be mounted in the RCP device 30 as a firmware.

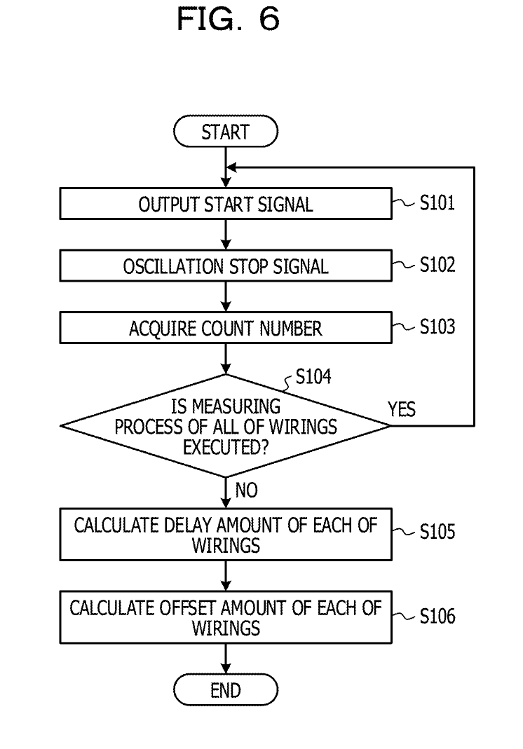

FIG. 6 is a flow chart of the offset amount calculating process executed by the CPU 35.

First, the measurement process instructing unit 351 outputs a selection instructing signal for selecting a signal being input from the delay amount measuring circuit 34 to the selecting circuit 33, and outputs the start signal to the adder 51 (S101). For example, the measurement process instructing unit 351 outputs the selection instructing signal for selecting a signal input from the delay amount measuring circuit 34 and outputting the selected signal to the switch S1 to the selecting circuit 33. The start signal is output to the switch S1 through the adder 51 and the gate driver 14.

Subsequently, the measurement process instructing unit 351 outputs the oscillation stop signal to the second one-shot pulse circuit 55 after a predetermined measuring time elapses (S102). During a measuring time from outputting the start signal to stopping the oscillation stop signal by the measurement process instructing unit 351, the delay amount measuring circuit 34 counts the number of the second one-shot pulses and the system clocks CLK, and stores the counted count numbers Nd and Nck.

Subsequently, the count number acquiring unit 352 acquires the count numbers Nd and Nck which are counted from the delay amount measuring circuit 34 at a measuring time (S103), and stores the acquired count numbers in a memory which is not illustrated in association with the wiring selected by the selecting circuit 33.

Subsequently, the measurement process instructing unit 351 determines whether or not the measuring processes of the wirings connected to all of the switches S1 to S6 are finished (S104). It is determined that the measuring processes of the wirings connected to all of the switches S1 to S6 by the measurement process instructing unit 351 are not finished (NO in S104), and the process returns to S101. After that, the processes of S101 to S104 are repeated, until the measurement process instructing unit 351 switches the connection relationship of the selecting circuit 33, and determines that the measuring processes of the wirings connected to all of the switches S1 to S6 by the measurement process instructing unit 351 are finished (YES in S104).

When the measuring processes of all of the wirings are determined to be finished (YES in S104), the delay amount calculating unit 353 calculates the delay amount of each of the six wirings when the second one-shot pulse is transmitted to the power supply circuit through each of the six wirings (S105). Specifically, the delay amount calculating unit 353 calculates a delay amount delay using Equation (1) as follows.

$$delay = \frac{T ( Nck - Nd )}{2 Nck} \qquad ( 1 )$$

Here, the delay amount delay is a half value of the “delay amount Td in accordance with the distance of the reciprocation path of the control wiring 40” described with reference to FIG. 5. In addition, T indicates a cycle of the system clock CLK, Nd indicates the count number counted by the asynchronous counter 56, and Nck indicates the count number counted by the counter 57. The delay amount calculating unit 353 calculates the delay amount of each of the wirings connected to the switches S1 to S6 using Equation (1). Since the delay amount calculating unit 353 calculates the delay amount using Equation (1), the delay amount is calculated based on the oscillation cycle of the self-oscillation circuit.

Subsequently, the offset amount calculating unit 354 calculates the offset amount of each of the plurality of wirings, which is a difference between the maximum value of the delay amounts calculated by the delay amount calculating unit 353 and the delay amount of each of the six wirings (S106), and the calculated offset amount is stored in a memory.

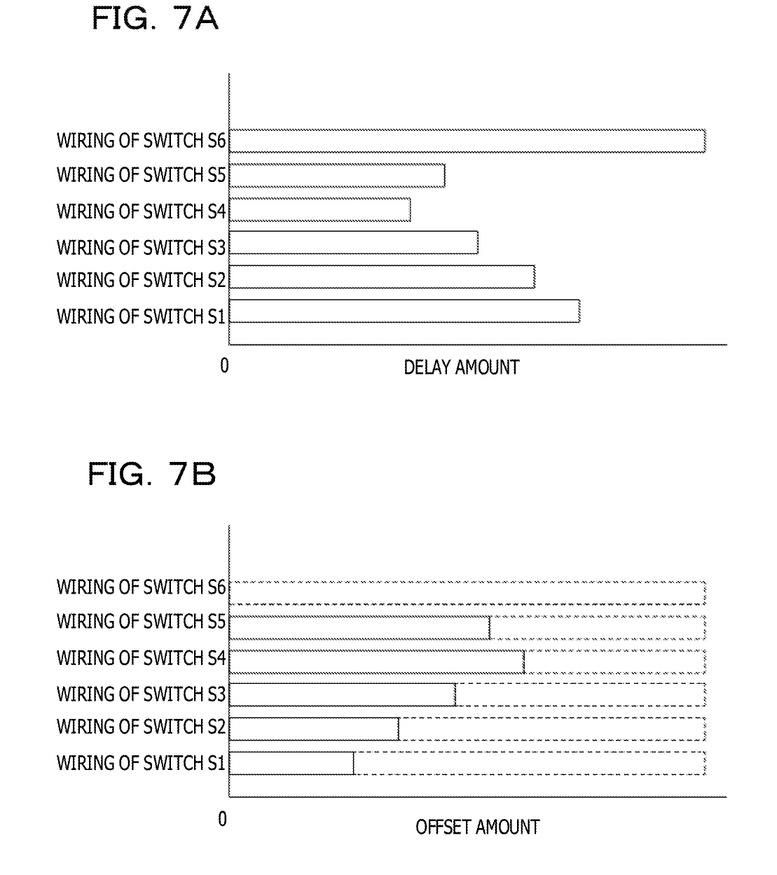

FIG. 7A is a diagram illustrating an example of the delay amount calculated by the delay amount calculating unit 353, and FIG. 7B is a diagram illustrating the offset amount calculated by the offset amount calculating unit 354 from the delay amount illustrated in FIG. 7A. In FIG. 7A, a horizontal axis indicates the delay amount, and the delay amount of each of the wirings is illustrated in a longitudinal direction of a solid line rectangle. In FIG. 7B, a horizontal axis indicates the offset amount, the offset amount of each of the wirings is illustrated in a longitudinal direction of a solid line rectangle, and the delay amount of each of the wirings is illustrated in the longitudinal direction of a broken line rectangle.

In the example illustrated in FIG. 7A, the delay amount of the wiring connected to the switch S6 is the largest, the delay amount of each of the wirings connected to the switches S1, the switches S2, the switches S3, the switches S5, and the switches S4 decreases in this order.

As illustrated in FIG. 7B, the offset amount of the wiring connected to each of the switches S1 to S5 is calculated as a difference between the delay amount of the wiring connected to S6, which is the maximum value, and each delay amount.

The RCP process executing unit 355 executes the RCP process when the PWM signal processing unit 31 delays the PWM signal by the offset amount in accordance with each of the wirings connected to the switches S1 to S6 and outputs the signal to the power supply circuit 10. The RCP process executing unit 355 outputs the compensation value data to the PWM signal processing unit 31, such that the PWM signal processing unit 31 outputs the compensated PWM signal and thus an output voltage of the power supply circuit 10 matches a target value.

### Action Effect of RCP System According to Embodiment

The RCP system according to the embodiment is capable of verifying the correctness of the control model without being influenced by the delay amounts of the wirings, because the RCP process is executed using signals delayed by the offset amounts calculated from the delay amounts of the plurality of wirings connected between the RCP device and the power supply circuit.

In addition, since the RCP system according to the embodiment calculates the delay amount based on the oscillation cycle of the oscillation circuit in accordance with the length of each of the plurality of wirings, the delay amount of each of the wirings can be accurately calculated with a simple circuit configuration.

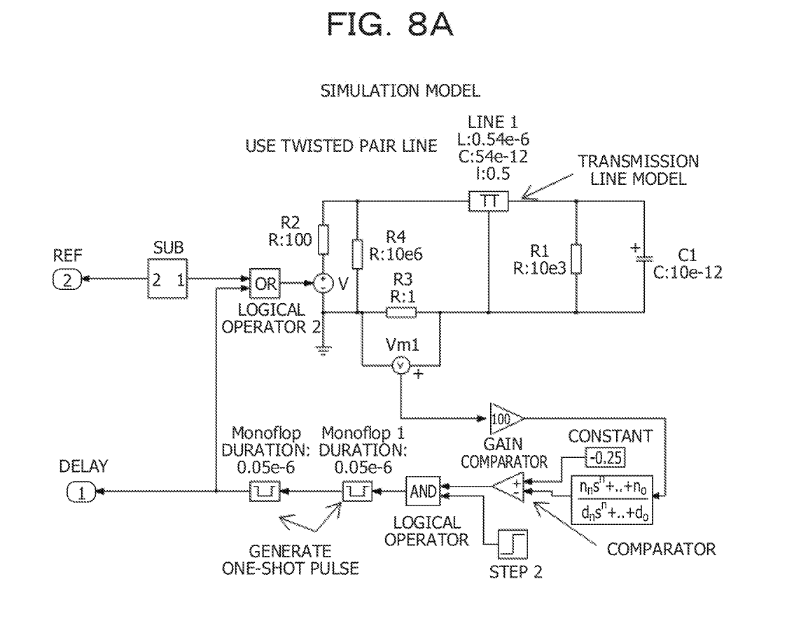

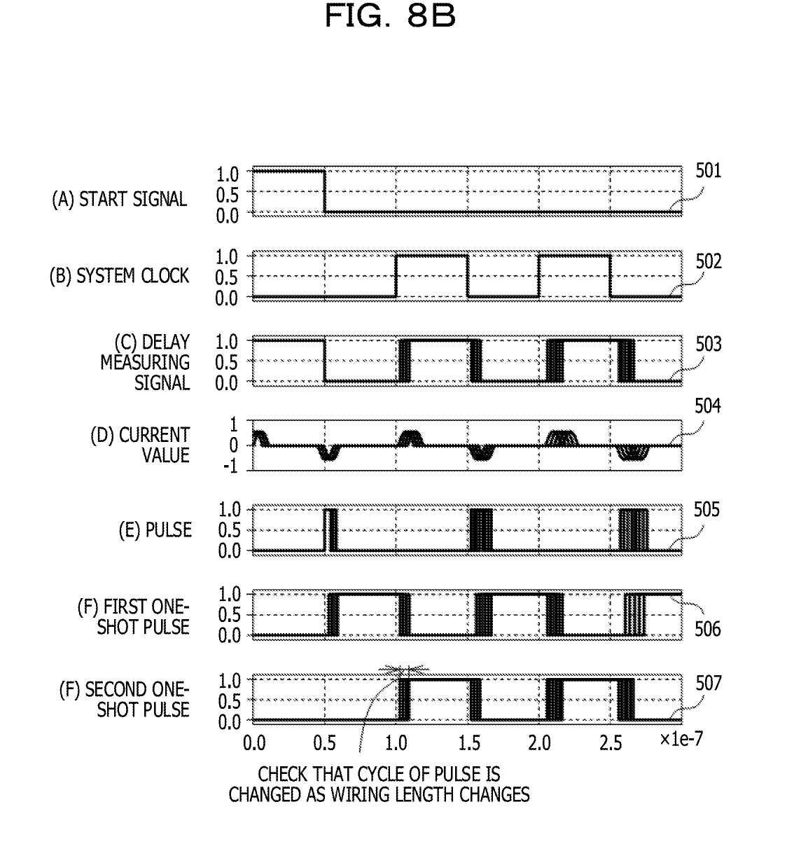

FIG. 8A is a diagram illustrating the simulation model in which an operation simulation of the delay amount measuring circuit 34 is executed, and FIG. 8B is a first diagram illustrating a simulation result executed using the simulation model of FIG. 8A. In FIG. 8B, since the waveforms 501 to 507 are the same as those of the waveforms of FIG. 5 to which the same numerals are given, detailed description thereof will be omitted herein.

In the example illustrated in FIGS. 8A and 8B, the simulation is executed by changing the wiring length of each of the wirings indicated by transmission line models from 100 mm to 500 mm. As illustrated in FIG. 8B, it is checked that a cycle of a pulse is changed as the wiring length changes.

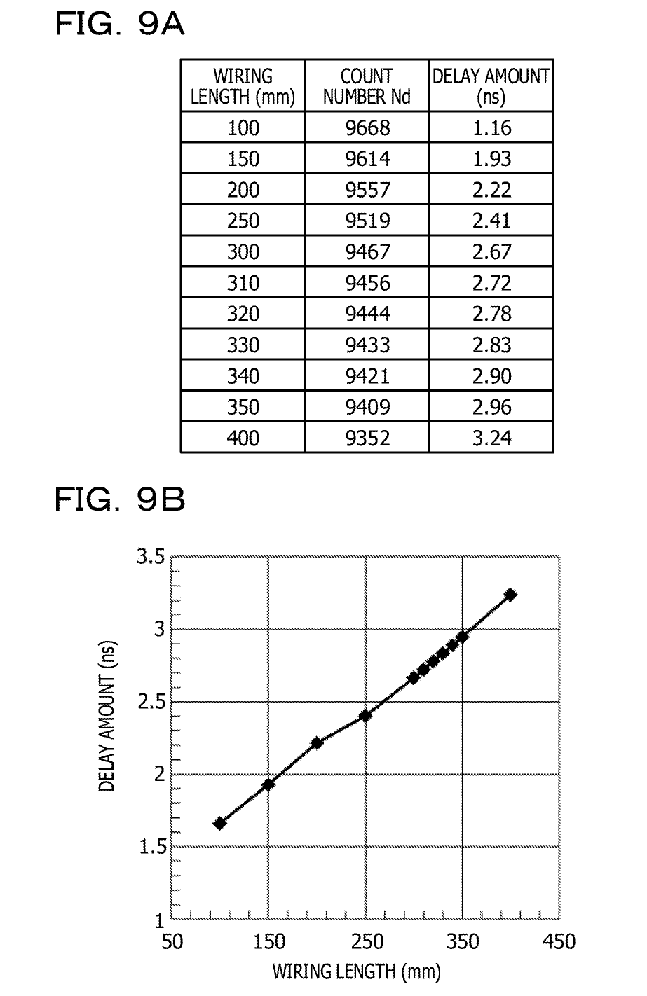

FIG. 9A is a second diagram illustrating a simulation result which is executed using the simulation model of FIG. 8A, and FIG. 9B is a diagram illustrating a relationship between a wiring length and a delay amount in a simulation result illustrated in FIG. 9A. In FIG. 9B, a horizontal axis indicates a wiring length, and a vertical axis indicates a delay amount which is calculated using the simulation model.

FIG. 9A illustrates the simulation result when a frequency of the system clock CLK is 10 MHz and a measuring time is 1 ms. Therefore, a cycle T of the system clock CLK in Equation (1) is 100 ns, and the count number Nck is 10,000.

Since the delay amount of each of the wirings is integrated as a difference between the count number of the system clock CLK and the count number of the pulse being generated by the self-oscillation circuit formed inside, the delay amount measuring circuit according to the embodiment is capable of calculating the delay amount of each of the wirings using the simple calculation equation illustrated as Equation (1).

In addition, in the delay amount measuring circuit according to the embodiment, since the count number being used for calculation can be easily increased as the measuring time increases, it is possible to calculate the delay amount with a high accuracy even when the system clock CLK is slow.

### Modification Example of RCP System According to Embodiment

In the RCP system 1, a target device that executes the RCP process is the power supply circuit; however, in the RCP system according to the embodiment, a target device that executes the RCP process may be a device other than the power supply circuit. For example, in the RCP system according to the embodiment, the target device that executes the RCP process may be an ECU which is mounted in a vehicle or the like.

In addition, in the RCP system 1, the power supply circuit 10 includes the six switches S1 to S6; however, in the RCP system according to the embodiment, the power supply circuit may include the number, such as four or twelve other than six, of the switches.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A rapid control prototyping system comprising:
a power supply circuit;
a control circuit coupled to the power supply circuit by a plurality of wirings and controls the power supply circuit, the control circuit including
a delay amount measuring circuit that output pulses to the power supply circuit by the plurality of wirings and counts reflected pulses by an input of the power supply circuit,
a processor that calculates a delay amount of each of the plurality of wirings according to count values of reflected pulses,
calculates an offset amount of each of the plurality of wirings which is a difference between a maximum value of the calculated delay amount, and
delays control signals that control the power supply circuit by the offset amount in accordance with each of the plurality of wirings when the control circuit controls the power supply circuit.

2. The rapid control prototyping system according to claim 1, wherein the processor outputs a PWM signal which is compensated for so that an output voltage of the power supply circuit matches a target value to the power supply circuit through each of the plurality of wirings.

3. The rapid control prototyping system according to claim 1, wherein
the delay amount measuring circuit includes a self-oscillation circuit in which an oscillation cycle, which is a cycle for generating the pulse, is determined in accordance with a length of each of the plurality of wirings, and
wherein the processor calculates the delay amount based on the oscillation cycle of the self-oscillation circuit.
